(19) United States
(12) Patent Application Publication
(10) Pub. No.: US 2018/0243841 A1
(43) Pub. Date: Aug. 30, 2018

(54) DRILL

(71) Applicant: MITSUBISHI MATERIALS CORPORATION, Tokyo (JP)

(72) Inventor: Yoshitaka Nakanohara, Tokyo (JP)

(21) Appl. No.: 15/757,517

(22) PCT Filed: May 27, 2016
(86) PCT No.: PCT/JP2016/065726

§ 371 Date: Mar. 5, 2018

(30) Foreign Application Priority Data
Sep. 9, 2015 (JP) 2015-177750

(51) Int. Cl. B23B 51/02

(52) U.S. Cl. CPC B23B 51/02; B23B 2251/043; B23B 2251/082; B23B 2251/122; B23B 2251/408

(57) ABSTRACT

The drill of the present invention includes: a drill main body; a chip discharge flute extending from a tip flank face of the drill main body toward a rear end side of the drill main body and formed on an outer circumference of a tip part of the drill main body; a margin formed at an opposite side of the chip discharge flute in the drill rotation direction; and a body clearance formed at an opposite side of the margin in the drill rotation direction and having an outer diameter smaller than that of the margin. A surface roughness of the body clearance at least along a circumferential direction is equal to or less than a surface roughness of the margin.

### TECHNICAL FIELD

The present invention relates to a drill including: a drill main body configured to be rotated about an axis; a chip discharge flute formed on an outer circumference of a tip part of the drill main body; and a cutting edge formed on an intersecting ridge between a wall surface of the chip discharge flute facing a drill rotation direction and a tip flank face of the drill main body.

Priority is claimed on Japanese Patent Application No. 2015-177750, filed on Sep. 9, 2015, the content of which is incorporated herein by reference.

### BACKGROUND ART

As such a drill, for example, PTL 1 provides a drill in which at least two round bevels are formed at intervals on lands between at least two chip discharge flutes twisting on the drill main body and have an inclined angle with respect to the axis larger than the twist angle of the chip discharge flute and smaller than 90°. PTL 1 describes that according to this drill, it is possible to achieve good lubrication of the round bevels, prevent wear thereof, and improve the guide performance and concentricity.

### CITATION LIST

### Patent Literature

PTL 1: International Patent Application Publication No. 2014/095395

### SUMMARY OF INVENTION

### Technical Problem

In a case of forming a machined hole oblique to the machined surface of workpiece by such a drill, when drilling is performed, for example, by feeding the drill main body in the vertical direction so as to be inclined with respect to an inclined plane of the workpiece, there is a portion contacting with the workpiece in the circumferential direction and a portion not contacting therewith on the outer circumferential surface of the drill main body, especially at the time when the cutting edge of the drill main body starts to bite the workpiece. Therefore, there is a concern that the drill main body may bend toward the portion not contacting therewith due to frictional resistance acting on the portion contacting therewith and the position of the rotational center of the tip of the drill main body may become unstable, thereby causing a shift of the position of the machined hole and impairing accuracy of the machined hole.

Here, in the drill disclosed in PTL 1, since the at least two round bevels are formed at intervals, the concave grooves are formed on these intervals, and the area of the outer circumferential surface of the drill main body (the outer circumferential surfaces of the lands) contacting with the workpiece is decreased. Thereby, the resistance acting on the portion of the outer circumferential surface contacting with the workpiece is reduced. However, since the round bevels have the above-mentioned inclined angle, both of the at least two round bevels contact with the workpiece, especially when the feed per revolution of the drill main body is relatively small, and therefore the frictional resistance cannot be reliably reduced. Accordingly, the shift of the position of the machined hole cannot be suppressed sufficiently.

The present invention has been made in view of such a background, and the objective thereof is to provide a drill which can sufficiently suppress a shift of the position of a machined hole even in a case of forming the machined hole oblique to the machined surface of workpiece.

### Solution to Problem

In order to solve the above problems and achieve the objective, the present invention provides a drill including: a drill main body configured to be rotated about an axis; a chip discharge flute extending from a tip flank face of the drill main body toward a rear end side of the drill main body and formed on an outer circumference of a tip part of the drill main body; a cutting edge formed on an intersecting ridge between a wall surface of the chip discharge flute facing a drill rotation direction and the tip flank face, a margin formed on an outer circumferential surface of the tip part of the drill main body at an opposite side of the chip discharge flute in the drill rotation direction; and a body clearance formed at an opposite side of the margin in the drill rotation direction and having an outer diameter smaller than that of the margin, in which a surface roughness of the body clearance at least along a circumferential direction is equal to or less than a surface roughness of the margin.

In the drill configured as described above, on the outer circumferential surface of the tip part of the drill main body, the margin is formed at an opposite side of the chip discharge flute in the drill rotation direction and the body clearance with an outer diameter smaller than that of the margin is formed at an opposite side of the margin in the drill rotation direction. That is, the body clearance is located at the inner peripheral side of the drill main body with respect to the machined hole formed in the workpiece, and thus it is possible to decrease the contact area between the outer circumferential surface of the drill main body and the workpiece. Further, when the machined hole is formed oblique to the machined surface of the workpiece, even in a case where the body clearance contacts with the workpiece due to bending of the drill main body as described above, it is possible to reliably reduce the frictional resistance acting on the drill main body due to the contact since the surface roughness of the body clearance at least along the circumferential direction is equal to or less than the surface roughness of the margin.

Therefore, according to the drill with the above-described configuration, it is possible to sufficiently suppress a shift of the position of the machined hole due to this resistance and thus to improve the accuracy of the machined hole. In addition, since the surface roughness of the body clearance at least along the circumferential direction is equal to or less than the surface roughness of the margin, the frictional resistance can be reduced even when the feed per revolution of the drill main body is relatively small Obviously, the surface roughness of the body clearance along the direction of the axis of the drill main body may be equal to or less than the surface roughness of the margin.

Here, it is preferable that the surface roughness of the body clearance at least along the circumferential direction may be 0.1 μm or less in an arithmetic average roughness Ra. When the surface roughness of the body clearance at least along the circumferential direction is larger than Ra 0.1 μm, there is a concern that the resistance caused by contact with the workpiece may not be reliably reduced.

In order to finish the body clearance with this surface roughness, for example, polishing or lapping may be performed on the body clearance toward to the direction of the axis of the drill main body. In this case, the surface roughness of the body clearance along the direction of the axis can be equal to or less than that of the margin and the shiny body clearance can be formed. In addition, using a grinding wheel containing abrasive grains with relatively small grain size, grinding may be performed on the body clearance toward the circumferential direction of the drill main body. In this case, the body clearance is not shiny compared to that in the case of performing polishing or lapping thereon, and in the microscopic sense, a plurality of ground parts are formed so as to extend in the circumferential direction and be parallel to each other in the direction of the axis.

Moreover, in a case of forming a counterbore inclined with respect to an inclined plane of the workpiece as described above, it is preferable that a point angle of the cutting edge be 160° to 180°, which is larger than that of common drills. In a common drill having a cutting edge, for example, with the point angle of 118°, when the cutting edge bites the inclined plane of the workpiece, a component force acting in a radial direction with respect to the axis becomes large. On the other hand, by increase the point angle as described above, it is possible to suppress such a component force in the radial direction and thereby to more sufficiently suppress the shift of the position of the machined hole.

### Advantageous Effects of Invention

As described above, according to the present invention, in a case of forming a machined hole obliquely with respect to a machined surface of a workpiece, it is possible to reduce frictional resistance acting on the drill main body from portion of the outer circumferential surface of the drill main body contacting with the workpiece, to sufficiently suppress a shift of the position of the machined hole, and thereby to improve accuracy of the machined hole.

### BRIEF DESCRIPTION OF DRAWINGS

FIG. 1 is a front view of a tip part of a drill main body showing the first embodiment of the present invention.

FIG. 2 is a side view of the tip part of the drill main body viewed along the direction of the arrow X in FIG. 1.

FIG. 3 is a side view of the tip part of the drill main body viewed along the direction of the arrow Y in FIG. 1.

FIG. 4 is a side view of the tip part of the drill main body viewed along the direction of the arrow X in FIG. 1 and showing the second embodiment of the present invention.

FIG. 5 is a side view of the tip part of the drill main body viewed along the direction of the arrow Y in FIG. 1 and showing the second embodiment of the present invention.

### DESCRIPTION OF EMBODIMENTS

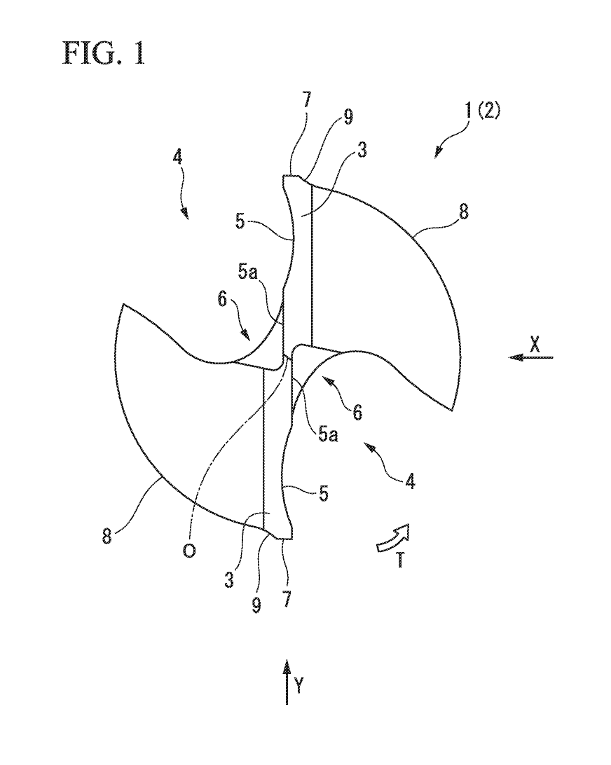

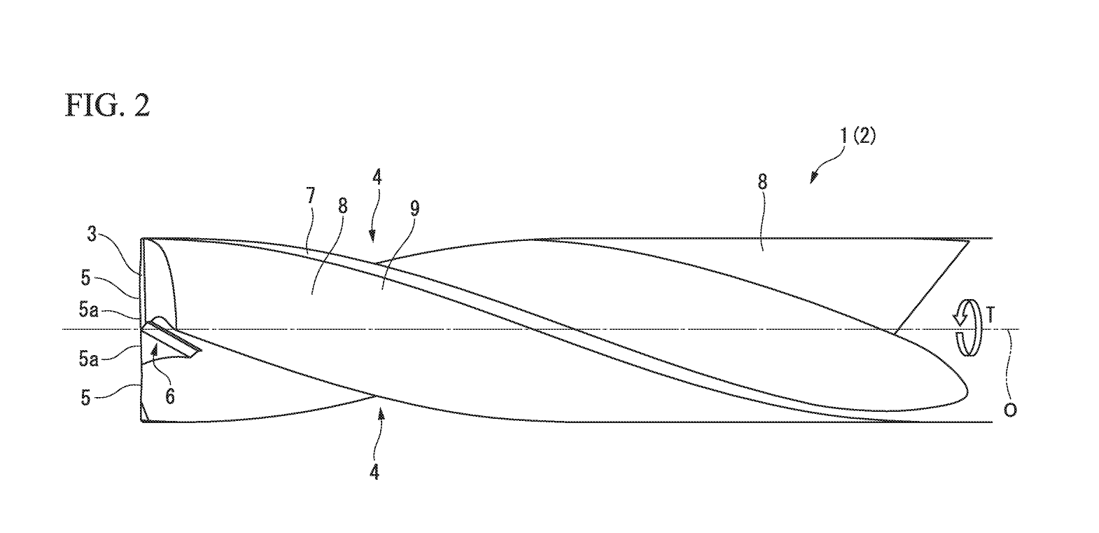

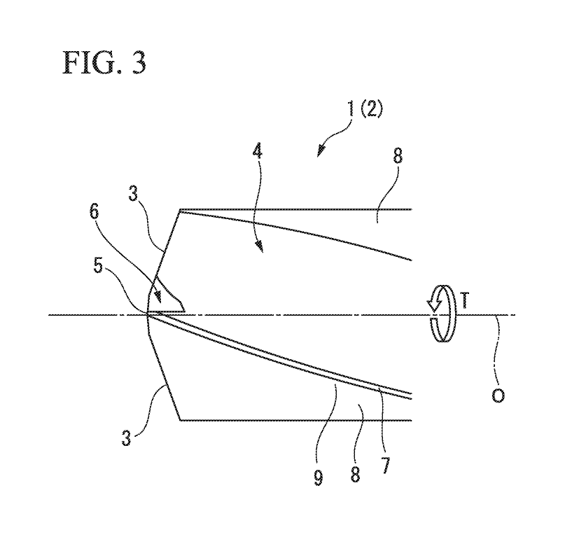

FIGS. 1 to 3 show the first embodiment of the present invention. In the present embodiment, the drill main body 1 is made of a hard material such as cemented carbide and formed so as to have a columnar outer shape centered on an axis O. The not-shown posterior end potion of the drill main body 1 (part at right side in FIGS. 2 and 3) is columnar and served as a shank portion. The tip part (part at left side in FIGS. 2 and 3) is served as a cutting edge portion 2.

The shank portion is held by a main spindle of a machine tool, and this drill is fed toward the tip side in the direction of the axis O while being rotated about the axis O in a drill rotation direction shown as reference numeral T in FIG. 1, so as to perform drilling on the workpiece using the cutting edge portion 2.

On the outer circumference of the cutting edge portion 2 as the tip part of the drill main body 1, chip discharge flutes 4 which opens to the tip surface of the cutting edge portion 2, that is, a tip flank faces 3 as the tip surface of the drill main body 1 and which extends toward the rear end side of the drill main body 1 in the direction of the axis O, are formed. The drill of the present embodiment is a twist drill with a two flutes, in which the two chip discharge flutes 4 are formed so as to be symmetrical to the axis O and be twisted toward the opposite side to the drill rotation direction T while being closer to the rear end side of the drill main body 1 in the direction of the axis O (that is, formed helically), and a pair of cutting edges 5 is formed on intersecting ridge portions between wall surfaces of the chip discharge flutes 4 facing the drill rotation direction T and the tip flank faces 3.

On the inner peripheral portion of the tip of each chip discharge flute 4, a thinning portion 6 is formed so as to cut off the chip discharge flute 4 toward the inner peripheral side thereof. On each of intersecting ridges between wall surfaces of the thinning portions 6 facing the drill rotation direction T and the tip flank faces 3, a thinning edges 5a constituting the inner peripheral portion of the cutting edge 5 is formed. In the present embodiment, when viewed from the tip side in the direction of the axis O, the thinning edges 5a are formed in a substantially linear shape. The cutting edge 5 is formed in a concave curve from the thinning edge 5a toward the outer peripheral side of the drill main body 1 and a linear shape at the outer peripheral side of the drill main body 1, the concave curve intersects with the thinning edge 5a at an obtuse angle and is concave toward the opposite side of the drill rotation direction, and the linear shape intersects with the concave curve at an obtuse angle and extends substantially along the extension of the thinning edge 5a to reach the outer circumference of the cutting edge portion 2.

In addition, in the side view where the drill is viewed from a direction facing the wall face of the tip part of the chip discharge flute 4 facing the drill rotation direction T as a rake face of the cutting edge 5, as shown in FIG. 2, the cutting edge 5 extends in a direction substantially orthogonal to the axis O formed so as to be substantially disposed on one plane perpendicular to the axis O. That is, a point angle of the cutting edges 5 (the angle between the cutting edges 5) is about 180°. Further, the tip flank face 3 is constituted by a plurality stages (two stages in the present embodiment) of flank faces with flank angles which become larger toward the opposite side in the drill rotation direction T.

On the other hand, on the outer circumferential surface of the cutting edge portion 2 of the drill main body 1 (each of the outer circumferential surfaces of lands between the chip discharge flutes 4), a margin 7 continuous with the opposite side of the chip discharge flute 4 in the drill rotation direction T is formed, and a body clearance 8 with the outer diameter smaller than that of the margin 7 is formed at the opposite side of the margin 7 in the drill rotation direction T. All of the margins 7 and the body clearances 8 are formed in a cylindrical surface centered on the axis O. The outer diameter of the margin 7 is equal to that of the cutting edge 5 (the diameter of the circle formed by the outer peripheral end of the cutting edge 5 on the rotation locus thereof about the axis O). The width of the body clearance 8 in the circumferential direction (in the direction along the drill rotation direction T) is larger than that of the margin 7.

Further, the margin 7 and the body clearance 8 are continuous with each other in a stepped shape so that a recessed curved face 9 which intersects with the margin 7 at an obtuse angle and contacts with the body clearance 8 (is smoothly continuous with the body clearance 8) is interposed therebetween.

The surface roughness of the body clearance 8 at least along the circumferential direction of the drill main body 1 is equal to or less than the surface roughness of the margin 7 (the surface roughness of the margin 7 along the circumferential direction). Further, in the present embodiment, the surface roughness of the body clearance 8 at least along the circumferential direction is Ra 0.1 μm or less in an arithmetic average roughness Ra based on JIS B 0601-2001 (which is JIS B 0601-2013 at present and corresponds with ISO 4287:1997). Since the surface roughness of the body clearance 8 at least along the circumferential direction is equal to or less than the surface roughness of the margin 7, it may be set to be equal to the surface roughness of the margin 7 or less than the surface roughness of the margin 7. In the present embodiment, the surface roughness of the body clearance 8 is equal to the surface roughness of the margin 7, and both are 0.1 μm. The surface roughness of the body clearance 8 and the margin 7 is measured in accordance with JIS B 0601-2001.

The body clearance 8 with such a surface roughness is finished by, in the present embodiment, forming the body clearance 8 in a predetermined outer diameter through grinding using a grinding wheel and then subjecting the body clearance 8 to polishing or lapping. A general formation of the body clearance 8 through grinding is performed by, in the circumferential direction, repeating a step of relatively moving the grinding wheel helically along the twist of the chip discharge flute 4 in the direction of the axis O while rotating the grinding wheel. However, the surface roughness thereof is worse as it is, since boundary portions formed by a plurality times of grinding become microscopic steps. In contrast, by performing polishing or lapping thereafter, the above-described surface roughness in the circumferential direction can be obtained. In a case of performing such polishing or lapping, the body clearance 8 is shiny, the surface roughness in the direction of the axis O can be the above-described surface roughness.

In the drill configured as described above, on the outer circumferential surface of the cutting edge portion 2 of the tip part of the drill main body 1, the margin 7 is formed at the opposite side of the chip discharge flute 4 in the drill rotation direction T, and the body clearance 8 with the outer diameter smaller than that of the margin 7 is formed at the opposite side of the margin 7 in the drill rotation direction T. Accordingly, the body clearance 8 is located at inner peripheral side of the inner circumferential surface of the machined hole formed on the workpiece by cutting edge 5 so as to be spaced from the inner circumferential surface. Therefore, it is possible to decrease the contact area between the outer circumferential surface of the drill main body 1 and the workpiece. Additionally, even when the drill main body 1 is bent when the machined hole is formed oblique to the machined surface of workpiece, it is possible to prevent the body clearance 8 from contacting with the inner circumferential surface of the machined hole.

Even when the body clearance 8 contacts with the inner circumferential surface of the machined hole of the workpiece due to the bending of the drill main body 1, in the drill with the above-described configuration, the surface roughness of the body clearance 8 at least along the circumferential direction is equal to or less than the surface roughness of the margin 7, and thus it is possible to reduce frictional resistance acting on the drill main body 1 in the radial direction orthogonal to the axis O due to the contact. Therefore, it is possible to feed the drill main body 1 straightforwardly along the axis O and sufficiently suppress the shift of the position of the machined hole, and a high degree of accuracy of the machined hole can be obtained.

In the drill with the above-described configuration, the surface roughness of the body clearance 8 measured at least along the circumferential direction of the drill main body 1 is equal to or less than the surface roughness of the margin 7. Therefore, even when the feed per revolution of the drill main body 1 is relative small, it is possible to reduce the frictional resistance due to contact with the workpiece and thereby suppress the shift of the position of the machined hole. Additionally, in the present embodiment, the surface roughness of the body clearance 8 measured along the direction of the axis O is equal to or less than the surface roughness of the margin 7 (the surface roughness of the margin 7 in the direction of the axis O). Therefore, the resistance at the time of feeding the drill while the body clearance 8 contacts the workpiece can be reduced, and thus it is possible to more reliably suppress a shift of the position of the machined hole.

Furthermore, in the present embodiment, the surface roughness of the body clearance 8 at least along the circumferential direction is Ra 0.1 μm or less in an arithmetic average roughness Ra based on JIS B 0601-2001. Therefore, the frictional resistance due to contact with the workpiece can be reduced more reliably and thus the accuracy of the machined hole can be improved. That is, when the surface roughness of the body clearance 8 along the circumferential direction exceeds Ra 0.1 μm, there is a concern that the resistance when contacting with the workpiece cannot be reduced sufficiently.

The smaller the surface roughness of the body clearance 8 along the circumferential direction is, the more the frictional resistance with the workpiece can be reduced, which is preferable. However, a surface roughness of 0 is impossible in practice, and thus it is preferable that the surface roughness of the body clearance 8 along the circumferential direction is Ra 0.05 μm to 0.1 μm, and it is more preferable that the lower limit thereof be Ra 0.07μm, but is not limited thereto. Similarly, the surface roughness of the body clearance 8 along the direction of the axis O is also preferably Ra 0.05 μm to 0.1 μm, and more preferably Ra 0.07 μm or more, but is not limited thereto. Further, in the present embodiment, the margin 7 has the surface roughness equal to that of the body clearance 8. Therefore, it is possible to reduce the frictional resistance acting on the drill main body 1 from the margin 7 which necessarily contacts with the workpiece, and thus the machined hole with further higher accuracy can be formed.

On the other hand, in the present embodiment, the cutting edges 5 are formed so as to be substantially disposed on the plane perpendicular to the axis O of the drill main body 1, and the point angle of the cutting edges 5 is about 180°. Therefore, the drill is suitable for forming counterbore of which bottom face is a plane perpendicular to the axis O. Further, in a case of forming a machined hole oblique to an inclined plane of the workpiece, by using the cutting edges 5 with the point angle of 180°, the component force acting in the radial direction with respect to the axis O when the cutting edge 5 bites the workpiece can be suppressed. Therefore, the shift of the position of the machined hole can be further sufficiently suppressed. In order to efficiently suppress the component force in the radial direction, the point angle is preferably 160° to 180°, and more preferably 175° to 180°, but is not limited thereto.

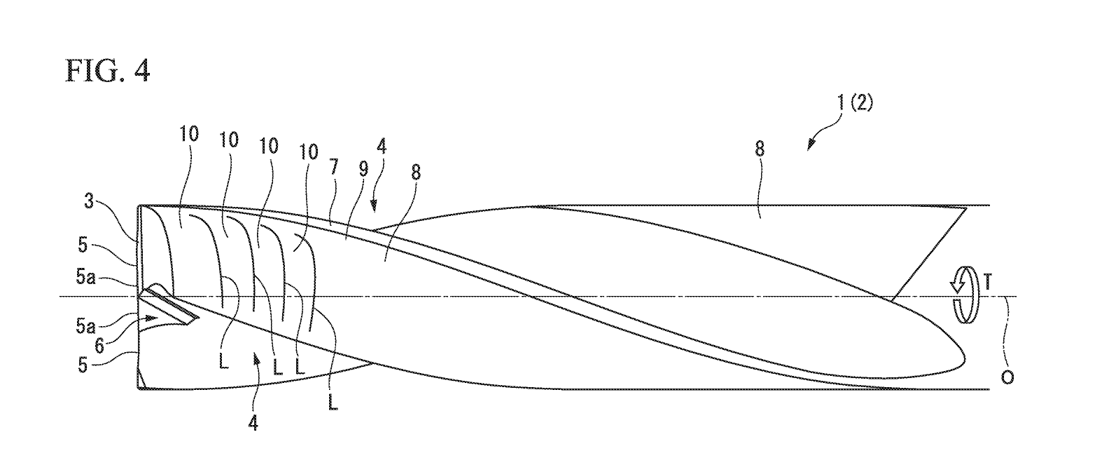

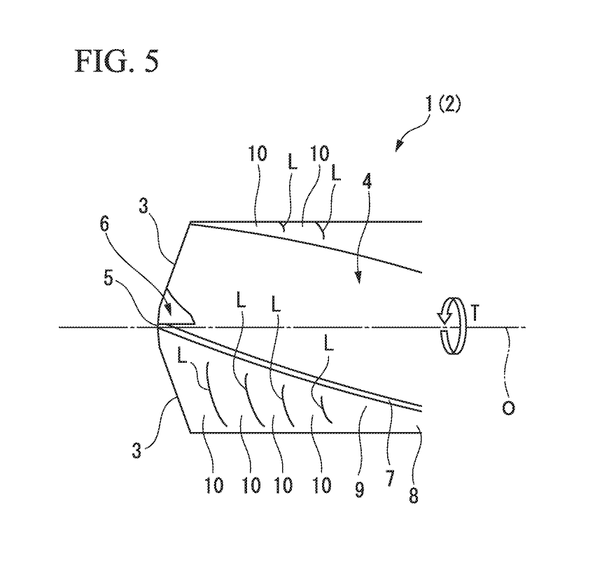

In the first embodiment, as described above, the body clearance 8 is subjected to polishing or lapping so as to have the surface roughness equal to or less than the surface roughness of the margin 7. However, the body clearance 8 only has to have the surface roughness at least along the circumferential direction of the drill main body 1 which is equal to or less than the surface roughness of the margin 7. Therefore, the surface roughness of the body clearance 8 along the circumferential direction may be set to be equal to or less than the surface roughness of the margin 7 by performing grinding on the body clearance 8 to have a predetermined outer diameter and then, in the direction of the axis O, repeating a step of performing grinding in the circumferential direction of the drill main body 1 on the body clearance 8 using grinding wheel as in the second embodiment shown in FIGS. 4 and 5. Here, the front view of the second embodiment is common to that of the first embodiment, the other parts of the second embodiment common to the first embodiment are put into the same reference numerals.

In the above-described second embodiment, the grinding in the circumferential direction of the drill main body 1 is repeated in the direction of the axis O, and thereby, as shown in FIGS. 4 and 5, a plurality of the ground parts 10 extending in the circumferential direction are formed on the body clearance 8 so as to be parallel to each other in the direction of the axis O. Here, although the boundaries L between the ground parts 10 are shown in FIGS. 4 and 5 for purpose of illustration, the boundaries L do not have to be visually confirmed. For example, when the surface roughness is measured along the direction of the axis O, the surface roughness of the parts between the boundaries L only has to be less than that of the vicinity of the boundaries L (the parts across the boundaries L). In addition, due to grinding using a grinding wheel, the body clearance 8 is not shinier than that in the first embodiment subjected to polishing or lapping.

In the second embodiment as described above, the surface roughness of the body clearance 8 along the circumferential direction is set to be equal to or less than the surface roughness of the margin 7, is preferably Ra 0.1 μm or less, and is more preferably Ra 0.05 μm to 0.1 μm in an arithmetic average roughness Ra based on JIS B 0601-2001. Thereby, it is possible to reduce the frictional resistance acting on the drill main body 1 in the radial direction with respect to the axis O due to contact of the body clearance 8 with the workpiece, and it is possible to sufficiently suppress the shift of the position of the machined hole and thus to improve the accuracy of the machined hole.

Additionally, the arrangement for polishing or lapping as in the first embodiment is not necessary, and the drill can be produced using machine tools such as a grinding machine for performing grinding on the body clearance 8 to have the predetermined outer diameter. Therefore, the processing cost can be reduced.

### EXAMPLE

Next, using Examples of the present invention, the effect of the present invention is described. First, in advance of the Example, as the Comparative example with respect to the Example, a drill was produced in accordance with the first embodiment except that the surface roughness of the body clearance was larger than the surface roughness of the margin. In the drill of the Comparative example, the outer diameter of the cutting edge (the outer diameter of the margin) was 6.0 mm, the outer diameter of the body clearance was 5.8 mm, the surface roughness of the body clearance along the circumferential direction was Ra 0.17 μm in an arithmetic average roughness Ra based on JIS B 0601-2001, and the surface roughness of the margin along the circumferential direction and the direction of the axis was Ra 0.10 μm.

This drill of the Comparative example was vertically fed downward at a feed per revolution of 0.07 mm and 0.15 mm to perform drilling to a depth of 12 mm on the plane of the workpiece made of S50C inclined at 45° with respect to the horizontal plane. At that time, the shift from the position of the extension of the axis O before the drill bit the workpiece to the center of the machined hole actually formed on the workpiece was measured. As a result, in the drill of the Comparative example, in the both cases where the feed was 0.07 mm and 0.15 mm, the shift amount from the position on the extension of the axis O was 200 μm or more downward the inclined side of the plane of the workpiece.

Next, the body clearance in the drill of the Comparative example was subjected to lapping, thereby producing the drill of the Example having the surface roughness of the body clearance along the circumferential direction of Ra 0.10 μm which was equal to the surface roughness of the margin. In the drill of the Example, the surface roughness of the body clearance along the direction of the axis O was also Ra 0.10 μm. Using this drill of the Example, the drilling was performed on the inclined plane of the workpiece under the same conditions as the Comparative example, and the shift of the position was measured. As a result, when the feed was 0.15 mm, the shift of the position was improved to about 100 μm. When the feed was 0.07 mm, the shift of the position was further suppressed to 50 μm or less.

### INDUSTRIAL APPLICABILITY

According to the present invention, even in a case of forming a machined hole oblique to a machined surface of a workpiece, it is possible to sufficiently suppress shift of a position of the machined hole, and thus drilling can be performed at a high accuracy.

### REFERENCE SIGNS LIST

1 Drill main body

2 Cutting edge portion (tip part of drill main body 1)

3 Tip flank face

4 Chip discharge flute

5 Cutting edge

7 Margin

8 Body clearance

10 Ground part

O Axis of drill main body 1

T Drill rotation direction

1. A drill comprising:
a drill main body configured to be rotated about an axis;
a chip discharge flute extending from a tip flank face of the drill main body toward a rear end side of the drill main body and formed on an outer circumference of a tip part of the drill main body;
a cutting edge formed on an intersecting ridge between a wall surface of the chip discharge flute facing a drill rotation direction and the tip flank face,
a margin formed on an outer circumferential surface of the tip part of the drill main body at an opposite side of the chip discharge flute in the drill rotation direction; and
a body clearance formed at an opposite side of the margin in the drill rotation direction and having an outer diameter smaller than that of the margin, wherein
a surface roughness of the body clearance at least along a circumferential direction is equal to or less than a surface roughness of the margin.

2. The drill according to claim 1, wherein
the surface roughness of the body clearance at least along the circumferential direction is 0.1 μm or less in an arithmetic average roughness Ra.

3. The drill according to claim 1, wherein
a plurality of ground parts are formed on the body clearance so as to extend in the circumferential direction and be parallel to each other in the direction of the axis.

4. The drill according to claim 1, wherein
a point angle of the cutting edge is 160° to 180°.

5. The drill according to claim 2, wherein
a plurality of ground parts are formed on the body clearance so as to extend in the circumferential direction and be parallel to each other in the direction of the axis.

6. The drill according to claim 2, wherein
a point angle of the cutting edge is 160° to 180°.

7. The drill according to claim 3, wherein
a point angle of the cutting edge is 160° to 180°.

8. The drill according to claim 5, wherein
a point angle of the cutting edge is 160° to 180°.
